(19) United States
(12) Patent Application Publication
(10) Pub. No.: US 2023/0235246 A1
(43) Pub. Date: Jul. 27, 2023

(54) DILUTABLE FABRIC CONDITIONER COMPOSITION

(71) Applicant: Conopco, Inc., d/b/a UNILEVER, Englewood Cliffs, NJ (US)

(72) Inventors: Gaurav PATHAK, Bangalore (IN); Dhanalakshmi THIRUMENI, Bangalore (IN)

(21) Appl. No.: 17/928,078

(22) PCT Filed: Apr. 28, 2021
(86) PCT No.: PCT/EP2021/061183

§ 371 Date: Nov. 28, 2022

(30) Foreign Application Priority Data
May 27, 2020 (IN) 202021022248
Jul. 15, 2020 (EP) 20186065.7

(51) Int. Cl. C11D 3/00; C11D 11/00; C11D 3/50; C11D 1/835

(52) U.S. Cl. CPC C11D 3/0015; C11D 1/835; C11D 3/505; C11D 11/0017; C11D 1/62

(57) ABSTRACT

A solid fabric conditioner composition suitable for diluting with water to produce a liquid fabric conditioner composition comprising, the solid fabric conditioner composition comprising: fabric softening system comprising cationic quaternary ammonium compound having more than one long carbon chain in combination with a secondary surfactant selected from a single chain cationic surfactant and/or a non-ionic surfactant; and thickening polymer.

### FIELD OF INVENTION

The present invention is in the field of fabric conditioners. In particular, solid fabric conditioning compositions which can be diluted with water by a consumer to create a liquid fabric conditioner composition.

### BACKGROUND OF INVENTION

Consumers are becoming more conscious of the environmental impact of the products they use. In particular, consumers are concerned with the vast amount of packaging used in their everyday lives. There is a need for more concentrated products, which can provide the same consumer benefits, but with smaller volumes of packaging.

WO 2007/141310 discloses a stable, concentrated (pre-dilute) aqueous fabric softening composition.

However, there is a need for increasingly more concentrated products requiring less packaging and less water to be shipped around the world, which must be balanced with the consumer habit and preference for liquid laundry products. Equally consumers still expect perceivable softening benefits to be delivered to the fabrics. Traditional fabric softening actives a generally formulated at high temperatures (above 50° C.) to ensure homogeneous mixing and suitable viscosity. However high temperature processing is not suitable for a dilute at home product.

It has surprisingly been found that the solid fabric conditioner compositions described herein can be provided in a solid format, diluted at home with water, and in use provides suitable viscosity and consumer acceptable softening performance.

### SUMMARY OF THE INVENTION

In a first aspect of the present invention is provided a solid fabric conditioner composition suitable for diluting with water to produce a liquid fabric conditioner composition comprising:
a. 15 to 80 wt.% Fabric softening system comprising cationic quaternary ammonium compound having more than one long carbon chain in combination with a secondary surfactant selected from a single chain cationic surfactant and/or a non-ionic surfactant; and
b. thickening polymer.

In a second aspect of the present invention is provided a method for in home preparation of a liquid fabric conditioner composition, where in a solid composition as described herein is diluted with water and a liquid fabric conditioner composition is produced, the method comprising the step of combining the solid composition and water.

In a third aspect of the present invention is provided a liquid fabric softening composition obtained by combining a solid fabric conditioner as described herein with water.

In a fourth aspect of the present invention is provided a use of a solid fabric treatment composition as described herein, to prepare a liquid fabric treatment composition.

### DETAILED DESCRIPTION OF THE INVENTION

These and other aspects, features and advantages will become apparent to those of ordinary skill in the art from a reading of the following detailed description and the appended claims. For the avoidance of doubt, any feature of one aspect of the present invention may be utilised in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

### Solid Fabric Conditioning Composition

The solid fabric conditioning composition may be in any form, such as powder, tablet, film, granules, bars, pastilles or pellets. Preferably the solid fabric conditioning composition is in the form of a tablet or powder.

The solid fabric conditioning composition preferably has an acidic pH when diluted with water. i.e. a pH of less than 7. Preferably the pH is in the range of 1.5 to 6, more preferably 1.5 to 4.5. The pH of the powder is measured by diluting a sample of the powder with water in a 1:5 weight ratio and using a pH probe to measure the resulting pH of the solution.

The solid fabric conditioning composition preferably comprises less than 10 wt.% of the composition water. Preferably less than 5 wt.% and more preferably less than 1 wt. %. In other words, the solid fabric conditioning composition comprise 0 to 10 wt.% of the composition water, preferably 0 to 5 wt.% and more preferably 0 to 1 wt.% water.

### Fabric Softening System

The solid fabric conditioning composition of the present invention comprise a fabric softening system. The fabric softening system comprises cationic quaternary ammonium compound having more than one long carbon chain in combination with a secondary surfactant selected from a single chain cationic surfactant and/or a non-ionic surfactant. Preferably the cationic quaternary ammonium compound having more than one long carbon chain and secondary surfactant are present in a ratio of 1:10 to 10:1, more preferably 1:5 to 5:1.

The combination of the cationic quaternary ammonium compound having more than one long carbon chain in combination with a secondary surfactant selected from a single chain cationic surfactant and/or a non-ionic surfactant provide a solid composition which can be diluted with water to form a stable liquid fabric softener and provides superior softening.

The solid fabric conditioning compositions of the present invention comprises more 15 wt. % fabric softening system, most preferably more than 25 wt. % fabric softening system. The solid fabric conditioning compositions of the present invention comprise less than 80 wt. % of the solid fabric conditioning composition fabric softening system, more preferably less than 70 wt. % fabric softening system, most preferably less than 60 wt.% fabric softening system. The solid fabric conditioning compositions comprises 15 to 80 wt.% fabric softening system, preferably 15 to 70 wt.% fabric softening system and most preferably 25 to 70 wt.% fabric softening system.

The cationic quaternary ammonium compound having more than one long carbon chain i.e. more than one carbon chain of 10 carbon atoms or more in length. These compounds preferably comprise at least one chain derived from fatty acids, more preferably at least two chains derived from a fatty acids. Generally fatty acids are defined as aliphatic monocarboxylic acids having a chain of 4 to 28 carbons. Preferably the fatty acid chains are palm or tallow fatty acids. Preferably the fatty acid chains of the QAC comprise from 10 to 50 wt. % of saturated C18 chains and from 5 to 40 wt. % of monounsaturated C18 chains by weight of total fatty acid chains. In a further preferred embodiment, the fatty acid chains of the QAC comprise from 20 to 40 wt. %, preferably from 25 to 35 wt. % of saturated C18 chains and from 10 to 35 wt. %, preferably from 15 to 30 wt. % of monounsaturated C18 chains, by weight of total fatty acid chains.

Preferred quaternary ammonium fabric compounds having more than one long carbon chain for use in compositions of the present invention are so called “ester quats”. Particularly preferred materials are the ester-linked triethanolamine (TEA) quaternary ammonium compounds comprising a mixture of mono-, di- and tri-ester linked components.

Typically, TEA-based fabric softening compounds comprise a mixture of mono, di- and tri ester forms of the compound where the di-ester linked component comprises no more than 70 wt.% of the fabric softening compound, preferably no more than 60 wt.% e.g. no more than 55%, or even no more that 45% of the fabric softening compound and at least 10 wt.% of the monoester linked component.

A first group of ester linked quaternary ammonium compounds suitable for use in the present invention is represented by formula (I):

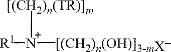

wherein each R is independently selected from a C5 to C35 alkyl or alkenyl group; R1 represents a C1 to C4 alkyl, C2 to C4 alkenyl or a C1 to C4 hydroxyalkyl group; T may be either O-CO. (i.e. an ester group bound to R via its carbon atom), or may alternatively be CO-O (i.e. an ester group bound to R via its oxygen atom); n is a number selected from 1 to 4; m is a number selected from 1, 2, or 3; and X- is an anionic counter-ion, such as a halide or alkyl sulphate, e.g. chloride or methylsulfate. Di-esters variants of formula I (i.e. m = 2) are preferred and typically have mono- and tri-ester analogues associated with them. Such materials are particularly suitable for use in the present invention.

Suitable actives include soft quaternary ammonium actives such as Stepantex VT90, Rewoquat WE18 (ex-Evonik) and Tetranyl L1/90N, Tetranyl L190 SP and Tetranyl L190 S (all ex-Kao). Preapagen™ TQL (ex-Clariant), and Tetranyl™ AHT-1 (ex-Kao), (both di-[hardened tallow ester] of triethanolammonium methylsulfate), AT-1 (di-[tallow ester] of triethanolammonium methylsulfate), and L5/90 (di-[palm ester] of triethanolammonium methylsulfate), (both ex-Kao), and Rewoquat™ WE15 (a di-ester of triethanolammonium methylsulfate having fatty acyl residues deriving from C10-C20 and C16-C18 unsaturated fatty acids) (ex-Evonik).

A second group of ester linked quaternary ammonium compounds suitable for use in the invention is represented by formula (ll):

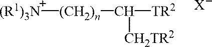

wherein each R1 group is independently selected from C1 to C4 alkyl, hydroxyalkyl or C2 to C4 alkenyl groups; and wherein each R2 group is independently selected from C8 to C28 alkyl or alkenyl groups; and wherein n, T, and X- are as defined above.

Preferred materials of this second group include 1,2 bis[tallowoyloxy]-3-trimethylammonium propane chloride, 1,2 bis[hardened tallowoyloxy]-3-trimethylammonium propane chloride, 1,2-bis[oleoyloxy]-3-trimethylammonium propane chloride, and 1,2 bis[stearoyloxy]-3-trimethylammonium propane chloride. Such materials are described in US 4, 137,180 (Lever Brothers). Preferably, these materials also comprise an amount of the corresponding mono-ester.

A third group of ester linked quaternary ammonium compounds QACs suitable for use in the invention is represented by formula (lll):

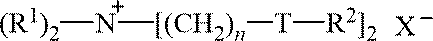

wherein each R1 group is independently selected from C1 to C4 alkyl, or C2 to C4 alkenyl groups; and wherein each R2 group is independently selected from C8 to C28 alkyl or alkenyl groups; and n, T, and X- are as defined above. Preferred materials of this third group include bis(2-tallowoyloxyethyl)dimethyl ammonium chloride, partially hardened and hardened versions thereof.

A particular example of the third group of ester linked quaternary ammonium compounds is represented the by the formula (IV):

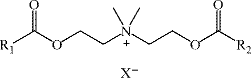

A fourth group of ester linked quaternary ammonium compounds suitable for use in the invention are represented by formula (V)

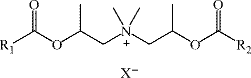

R1 and R2 are independently selected from C10 to C22 alkyl or alkenyl groups, preferably C14 to C20 alkyl or alkenyl groups. X- is as defined above.

The iodine value of the ester linked quaternary ammonium fabric conditioning material is preferably from 0 to 80, more preferably from 0 to 60, and most preferably from 0 to 45. The iodine value may be chosen as appropriate. Essentially saturated material having an iodine value of from 0 to 5, preferably from 0 to 1 may be used in the compositions of the invention. Such materials are known as “hardened” quaternary ammonium compounds. A further preferred range of iodine values is from 20 to 60, preferably 25 to 50, more preferably from 30 to 45. A material of this type is a “soft” triethanolamine quaternary ammonium compound, preferably triethanolamine di-alkylester methylsulfate. Such ester-linked triethanolamine quaternary ammonium compounds comprise unsaturated fatty chains.

If there is a mixture of ester linked quaternary ammonium materials present in the composition, the iodine value, referred to above, represents the mean iodine value of the parent fatty acyl compounds or fatty acids of all of the ester linked quaternary ammonium materials present. Likewise, if there are any saturated ester linked quaternary ammonium materials present in the composition, the iodine value represents the mean iodine value of the parent acyl compounds of fatty acids of all of the ester linked quaternary ammonium materials present.

Iodine value as used in the context of the present invention refers to, the fatty acid used to produce the ester linked quaternary ammonium compounds, the measurement of the degree of unsaturation present in a material by a method of nmr spectroscopy as described in Anal. Chem, 34, 1136 (1962) Johnson and Shoolery.

Suitable single chain cationic surfactant preferably have the general formula:

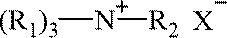

Wherein each R₁ independently comprises 1 to 6 carbon atoms, selected from alky, alkenyl, aryl or combinations thereof. Each R₁ may independently comprise hydroxy groups. Preferably at least two of the R₁ groups correspond to a methyl group.

Wherein R₂ comprises at least 10 carbon atoms. The carbon atoms may be in the form of an alky, alkenyl, aryl or combinations thereof. Preferably the single chain cationic surfactant comprises at least 12 carbon atoms, preferably at least 14 and most preferably at least 16. R₂ may further comprise additional functional groups such as ester groups or hydroxy groups.

X- is an anionic counter-ion, such as a halide or alkyl sulphate, e.g. chloride or methylsulfate

Preferred cationic surfactants include Hydroxyethyl laurdimonium chloride, cetyltrimethylammonium chloride (CTAC), Behentrimonium chloride (BTAC), a Alkyl dimethyl hydroxyethyl ammonium chloride such as Praepagen HY ex Clariant GmbH.

Suitable nonionic surfactants include addition products of ethylene oxide and/or propylene oxide with fatty alcohols, fatty acids and fatty amines. Any of the alkoxylated materials of the particular type described hereinafter can be used as the nonionic surfactant.

Suitable surfactants are substantially water soluble surfactants of the general formula (Vll):

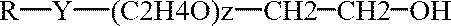

where R is selected from the group consisting of primary, secondary and branched chain alkyl and/or acyl hydrocarbyl groups; primary, secondary and branched chain alkenyl hydrocarbyl groups; and primary, secondary and branched chain alkenyl-substituted phenolic hydrocarbyl groups; the hydrocarbyl groups having a chain length of from 8 to about 25, preferably 10 to 20, e.g. 14 to 18 carbon atoms.

In the general formula for the ethoxylated nonionic surfactant, Y is typically:

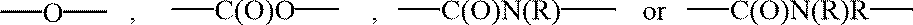

in which R has the meaning given above for formula (VII), or can be hydrogen; and Z is at least about 8, preferably at least about 10 or 11.

Preferably the nonionic surfactant has an HLB of from about 7 to about 20, more preferably from 10 to 18, e.g. 12 to 16. Genapol™ C200 (Clariant) based on coco chain and 20 EO groups is an example of a suitable nonionic surfactant.

A class of preferred non-ionic surfactants include addition products of ethylene oxide and/or propylene oxide with fatty alcohols, fatty acids and fatty amines. These are preferably selected from addition products of (a) an alkoxide selected from ethylene oxide, propylene oxide and mixtures thereof with (b) a fatty material selected from fatty alcohols, fatty acids and fatty amines.

A second class of preferred non-ionic surfactants are polyethylene glycol ethers of glycerine. Such as Glycereth-6 Cocoate, Glycereth-7 Cocoate and Glycereth-17 Cocoate.

Preferably the non-ionic surfactant is selected from addition products of ethylene oxide and/or propylene oxide with fatty alcohols, fatty acids and fatty amines and polyethylene glycol ethers of glycerine.

Suitable non-ionic surfactants are available commercially as Lutensol™ AT25 ex. BASF based on C16:18 chain and 25 EO groups is an example of a suitable non-ionic surfactant. Other suitable surfactants include Renex 36 (Trideceth-6), ex Croda; Tergitol 15-S3, ex Dow Chemical Co.; Dihydrol LT7, ex Thai Ethoxylate ltd; Cremophor CO40, ex BASF and Neodol 91-8, ex Shell; LEVENOL® F-200, LEVENOL® C-301 and LEVENOL® C-201 ex. Kao.

### Polymer

The solid fabric conditioner composition of the present invention comprises thickening polymer or mixtures of thickening polymers. The thickening polymer described herein is important for providing a consumer acceptable viscosity when the solid fabric conditioning composition is diluted with water to form a liquid fabric softening composition.

The solid fabric conditioning compositions of the present invention preferably comprise more than 0.1 wt.% of the solid fabric conditioning composition polymer, more preferably more than 0.25 wt. % polymer, most preferably more than 0.75 wt. % polymer. The solid fabric conditioning compositions of the present invention preferably comprise less than 10 wt. % of the solid fabric conditioning composition polymer, more preferably less than 5 wt. % polymer most preferably less than 3 wt.% polymer. Suitably, the solid fabric conditioning compositions may comprise 0.1 to 10 wt.% polymer, preferably 0.25 to 5 wt.% polymer and most preferably 0.5 to 3 wt.% polymer.

The thickening polymer may be anionic or non-ionic. Preferably that thickening polymer has an anionic charge. Anionic refers to polymers having an overall negative charge at a neutral pH (pH 7).

The polymer may be naturally derived or synthetic. The polymer of the present invention may be categorised as a polysaccharide-based polymer or non-polysaccharide based polymers. Polysaccharide polymers are preferred.

The molecular weight of the xanthan gum is preferably greater than 25 000 g/mol, more preferably greater than 50 000 g/mol. The molecular weight is preferably less than 50 000 000 g/mol, more preferably less than 20 000 000 g/mol.

Polysaccharides are polymers made up from monosaccharide monomers joined together by glycosidic bonds. Polysaccharide based polymers include: tamarind gum (preferably consisting of xyloglucan polymers), guar gum, locust bean gum (preferably consisting of galactomannan polymers), and other industrial gums and polymers, which include, but are not limited to, Tara, Fenugreek, Aloe, Chia, Flaxseed, Psyllium seed, quince seed, xanthan, gellan, welan, rhamsan, dextran, curdlan, pullulan, scleroglucan, schizophyllan, chitin, hydroxyalkyl cellulose, arabinan (preferably from sugar beets), de- branched arabinan (preferably from sugar beets), arabinoxylan (preferably from rye and wheat flour), galactan (preferably from lupin and potatoes), pectic galactan (preferably from potatoes), galactomannan (preferably from carob, and including both low and high viscosities), glucomannan, lichenan (preferably from Icelandic moss), mannan (preferably from ivory nuts), pachyman, rhamnogalacturonan, acacia gum, agar, alginates, carrageenan, chitosan, clavan, hyaluronic acid, heparin, inulin, cellodextrins, cellulose, cellulose derivatives and mixtures thereof. Preferred polysaccharides are selected from: celluloses, guars, xanthan gum, starches and combinations thereof.

The polysaccharide-based polymers present in the compositions of the invention may have a modified polysaccharide backbone, modified in that additional chemical groups have been reacted with some of the free hydroxyl groups of the polysaccharide backbone to give an overall charge to the modified cellulosic monomer unit, preferably an overall anionic charge.

A preferred polysaccharide polymer is xanthan gum. The primary structure of xanthan gum is a backbone of 1,4-linked β-D-glucose with side chains containing two mannose and one glucoronic acids. Preferably the xanthan gum is modified to have an overall anionic charge. The modification may include the addition of chemical groups which have been reacted with some of the free hydroxyl groups of the polysaccharide to give an overall negative charge to the modified cellulose monomer unit.

Examples of suitable xanthabn gums are Keltrol CG SFT and KELZAN AP AS ex. CP Kelco and RHODOPOL ex. Solvay

A non-polysaccharide-based thickening polymers are comprised of structural units, these structural units may be non-ionic, cationic, anionic or mixtures thereof. The polymer may comprise structural units which are not anionic, but the polymer must have a net anionic charge. The polymer may consists of only one type of structural unit, i.e., the polymer is a homopolymer. The thickening polymer may consists of two types of structural units, i.e., the polymer is a copolymer. The thickening polymer may consists of three types of structural units, i.e., the polymer is a terpolymer. The thickening polymer may comprises two or more types of structural units. The structural units may be described as first structural units, second structural units, third structural units, etc. The structural units, or monomers, may be incorporated in the thickening polymer in a random format or in a block format.

The thickening polymer may comprise a nonionic structural units derived from monomers selected from: (meth)acrylamide, vinyl formamide, N, N-dialkyl acrylamide, N, N-dialkylmethacrylamide, C1-C12 alkyl acrylate, C1-C12 hydroxyalkyl acrylate, polyalkylene glyol acrylate, C1-C12 alkyl methacrylate, C1-C12 hydroxyalkyl methacrylate, polyalkylene glycol methacrylate, vinyl acetate, vinyl alcohol, vinyl formamide, vinyl acetamide, vinyl alkyl ether, vinyl pyridine, vinyl pyrrolidone, vinyl imidazole, vinyl caprolactam, and mixtures thereof.

The thickening polymer may comprise anionic functional groups selected from: carboxylate, sulfate, sulfonate, phosphate, phosphonate or combinations thereof. An anionic structural unit derived from monomers selected from: acrylic acid (AA), methacrylic acid, maleic acid, vinyl sulfonic acid, styrene sulfonic acid, acrylamidopropylmethane sulfonic acid (AMPS) and their salts, and mixtures thereof.

The thickening polymer may be a crosslinked water swellable cationic polymer, for example a crosslinked water swellable polymer.

The polymer preferably has an average particle size of 10 to 500 µm, preferably 40 to 500 µm. Particle size is the largest diameter of the particle and may be measured using a microscope and micrometre.

### Perfume

The solid fabric conditioning compositions of the present invention may comprise perfume materials. The compositions suitably comprise 0.1 to 30 wt. % perfume materials i.e. free perfume and/or perfume microcapsules, by weight of the composition. As is known in the art, free perfumes and perfume microcapsules provide the consumer with perfume hits at different points during the wash cycle. It is particularly preferred that the compositions of the present invention comprise a combination of both free perfume and perfume microcapsules.

Preferably the composition of the present invention comprises 0.5 to 20 wt.% perfume materials.

Useful perfume components may include materials of both natural and synthetic origin. They include single compounds and mixtures. Specific examples of such components may be found in the current literature, e.g., in Fenaroli’s Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N.J. (USA). These substances are well known to the person skilled in the art of perfuming, flavouring, and/or aromatizing consumer products.

### Free Perfumes

The compositions of the present invention preferably comprise 0.1 to 18 wt. % free perfume by weight of the composition, more preferably 0.5 to 14 wt. % free perfume.

Particularly preferred perfume components are blooming perfume components and substantive perfume components. Blooming perfume components are defined by a boiling point less than 250° C. and a LogP or greater than 2.5. Substantive perfume components are defined by a boiling point greater than 250° C. and a LogP greater than 2.5. Boiling point is measured at standard pressure (760 mm Hg). Preferably a perfume composition will comprise a mixture of blooming and substantive perfume components. The perfume composition may comprise other perfume components.

It is commonplace for a plurality of perfume components to be present in a free oil perfume composition. In the compositions for use in the present invention it is envisaged that there will be three or more, preferably four or more, more preferably five or more, most preferably six or more different perfume components. An upper limit of 300 perfume components may be applied.

### Perfume Microcapsules

The compositions of the present invention preferably comprise 0.1 to 15 wt.% perfume microcapsules by weight of the composition, more preferably 0.5 to 8 wt. % perfume microcapsules. The weight of microcapsules is of the material as supplied.

When perfume components are encapsulated, suitable encapsulating materials, may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof. Particularly preferred materials are aminoplast microcapsules, such as melamine formaldehyde or urea formaldehyde microcapsules.

Perfume microcapsules of the present invention can be friable microcapsules and/or moisture activated microcapsules. By friable, it is meant that the perfume microcapsule will rupture when a force is exerted. By moisture activated, it is meant that the perfume is released in the presence of water. The compositions of the present invention preferably comprises friable microcapsules. Moisture activated microcapsules may additionally be present. Examples of a microcapsules which can be friable include aminoplast microcapsules.

Perfume components contained in a microcapsule may comprise odiferous materials and/or pro-fragrance materials.

Particularly preferred perfume components contained in a microcapsule are blooming perfume components and substantive perfume components. Blooming perfume components are defined by a boiling point less than 250° C. and a LogP greater than 2.5. Substantive perfume components are defined by a boiling point greater than 250° C. and a LogP greater than 2.5. Boiling point is measured at standard pressure (760 mm Hg). Preferably a perfume composition will comprise a mixture of blooming and substantive perfume components. The perfume composition may comprise other perfume components.

It is commonplace for a plurality of perfume components to be present in a microcapsule. In the compositions for use in the present invention it is envisaged that there will be three or more, preferably four or more, more preferably five or more, most preferably six or more different perfume components in a microcapsule. An upper limit of 300 perfume components may be applied.

The microcapsules may comprise perfume components and a carrier for the perfume ingredients, such as zeolites or cyclodextrins.

### Filler

The solid fabric conditioner compositions may preferably comprise soluble and/or insoluble filler. Preferably the filler is insoluble. The filler provides beneficial properties such as improving the flow of the powder and providing a carrier for any liquid ingredients. When selecting a suitable filler, consideration must be made to the desirable pH of the composition suitable filler materials include: silica, metal oxides, attapulgite, sodium sulphate, sodium acetate or sodium chloride.

Preferably the solid fabric conditioner compositions comprise 10 to 70 wt.% filler. More preferably 10 to 60 wt.%.

### Disintegrant

The solid fabric conditioning composition described herein may preferably comprise a disintegrant or disintegrant system.

The solid fabric conditioning composition of the present invention preferably comprise more than 10 wt.% of the composition disintegrant, more preferably more than 12 wt. % disintegrant, most preferably more than 15 wt. % disintegrant. The solid fabric conditioning composition of the present invention preferably comprise less than 40 wt. % of the composition disintegrant, more preferably less than 35 wt. % disintegrant, most preferably less than 25 wt.% disintegrant. Suitably, solid fabric conditioning composition may comprise 10 to 40 wt.% disintegrant, preferably 12 to 35 wt.% disintegrant and most preferably 15 to 25 wt.% disintegrant.

The disintegrant or integrant system may comprise a combination of salt and acid; polymeric disintegrants, clay disintegrants and combinations thereof.

Where an acid and salt are present., the salt is preferably a water soluble salt. The salt is preferably selected from anhydrous forms or hydrates of salts of mono or divalent alkali metals, preferably anhydrous forms or hydrates of salts of mono alkali metals, more preferably wherein the mono alkali metals is sodium or potassium. Preferably the salt is a carbonate salt.

Preferably, the anhydrous forms or hydrates of salts of mono alkali metals is selected from the group consisting of sodium carbonate, potassium carbonate, sodium hydrogen carbonate, potassium hydrogen carbonate, sodium glycine carbonate, potassium glycine carbonate, sodium bicarbonate, potassium bicarbonate and mixtures thereof.

The preferred ratio of carbonate salt : acid is between 0.75 : 1 to 1 : 0.75, more preferably the ratio of carbonate salt to acid is about 1:1. In some embodiments an additional water soluble salt may be present in addition to any carbonate salts present. The secondary water-soluble salt is a non-carbonate salt, such as sodium chloride or potassium chloride.

Preferably, the water soluble salt has 5 a solubility of at least 0.5 g/100 mL at 25° C., preferably at least 1 g/10 mL, more preferably at least 5 g/100 mL, even more preferably at least 10 g/100 mL, most preferably at least 10 g/100 mL at 25° C. Preferably, the water soluble salt has a solubility of at most 75 g/100 mL, more preferably at most 70 g/100 mL at 25° C., even more preferably at most 60 g/100 mL. In other words, the water soluble salt has a solubility of in the range of 0.5 g/100 mL to 75 g/100 mL at 25° C., preferably 1 g/100 mL to 70 g /100 mL at 25° C., more preferably 5 g/100 mL to 65 g/100 mL at 25° C., even more preferably 10 g/100 mL to 60 g/100 mL.

Where acid and any salt are present, preferably the acid is selected from organic acids. Organic acids may be monovalent or multivalent. Preferably the organic acid is multivalent, i.e. di or tri-valent. Preferably the organic acid comprises 10 or fewer carbon atoms, preferably 6 or fewer. Preferred examples of suitable organic acids include: citric acid, lactic acid, malic acid, succinic acid, tartaric acid, fumaric acid, malonic acid, glutaric acid, maleic acid. Most preferred is citric acid.

In a preferred aspect, the acid is encapsulated. The encapsulation material may be any hydrophobic material, preferably with a melting point between about 40° C. and about 60° C. Suitable materials include wax, oil and water soluble coatings. Preferably oils are used to encapsulate the citric acid, more preferable a vegetable oil. Citric acid encapsulated in plant oils are available from Extrakta Strauss and Anmol Chemicals.

Preferably the total salt and acid are present in a molar ratio of 1:1 to 10:1, more preferably 2.5:1 to 7.5:1, most preferably 4:1 to 6:1.

Where a polymeric disintegrant is present, preferably the polymer is a polymer which swells on contact with water or one which facilitates water influx and/or efflux by forming channels in the unit dose cleaning composition.

Polymeric components of the disintegrant system are preferably selected from the group consisting of starch and cellulose and derivatives thereof, alginates, sugars, polyvinylpyrrolidones and mixtures thereof. Examples of suitable polymers include starch and cellulose-based materials such as Arbocel (tradename), Vivapur (tradename) both available from Rettenmaier, Nymcel (tradename) available from Metsa-serla, burkeite, methyl cellulose, hydroxypropylcellulose, carboxymethylcellulose, cross-linked celluloses such as cross-linked carboxymethylcellulose (CMC), dextrans, cross-linked polyvinylpyrrolidones. Most preferably, the disintegrant system is microcrystalline cellulose.

Where a clay disintegrant is present, suitable clays are preferably selected from modified smectite clays and nano clays. Smectite clays include alkali and alkaline earth metal montmorillonites, saponites and hectorites. There are two distinct classes of smectite-type clays; in the first, aluminium oxide is present in the silicate crystal lattice; in the second class of smectites, magnesium oxide is present in the silicate crystal lattice. The general formulas of these smectites are Al2 (Si2 05)2 (OH)2 and Mg3 (Si2 O5)(OH)2, for the aluminium and magnesium oxide type clay, respectively. Smectites clay mineral containing materials useful in the present invention include dioctahedral and trioctahedral three layer smectite clays, ideally of the calcium and/or sodium montmorillonite type. Most preferably the clay is a bentonite such as a montmorillonite. Commercial examples of suitable clays include clays marketed under the trade name Pelben ex. Buntech, Laundrosil ex. Clariant and halloysite (widely available).

Where present the polymer and/or clay preferably has a particle size distribution such that at least 90% by weight thereof has a particle size below 0.3 mm and at least 30% by weight thereof has a particle size below about 0.2 mm, preferably a particle size distribution such that at least 90% by weight thereof has a particle size below about 0.25 mm and at least 50% by weight thereof has a particle size below about 0.2 mm, more preferably the polymer and/or clay has a particle size distribution such that at least 90% by weight thereof has a particle size above about 0.05 mm, preferably above about 0.075 mm.

The particles size distribution of the polymeric disintegrant system can suitably be determined by means of sieving in oil, i.e. by employing a set of sieves of different mesh sizes and by dispersing the cell wall material into a sufficient quantity of oil before sieving. This same technique can be used to determine the particle size distribution of other nonfat particulate components of the oil-continuous composition.

In one aspect of the present invention, the fabric softening active may be pre dispersed on the disintegrant or disintegrant system. This may be particularly preferred when a clay is present, a particularly preferred clay is nano clays such as halloysite.

### Antifoam

The solid fabric conditioner compositions may preferably comprise an antifoam or suds suppressing material. Suitable antifoam materials are preferably in granular form for use in solid fabric conditioner compositions, such as those described in EP 266863A (Unilever). Preferably antifoam materials may be selected from silicone oil, petroleum jelly, hydrophobic silica and fatty acids, more preferably silicone oil and fatty acids. Antifoam may be present in an amount up to 5% by weight of the composition. Preferably the solid fabric conditioner composition according to the present invention includes from 0.2 wt.% to 5 wt.% antifoam, preferably 0.5 wt.% to 5 wt.%.

### Preservative

The solid fabric conditioner compositions may preferably comprise a preservative. Although the composition is self preserving against most mould and bacteria, a preservative may be desired to prevent the growth of certain specific moulds or bacteria. Suitable preservatives may include BIT, CMIT/MIT, DMDMH Hydantoin, Sodium Pyrithione and N-(3-aminopropyl)-N-dodecylpropane-1,3-diamine and combinations thereof.

### Other Ingredients

The solid compositions of the present invention may comprise other ingredients of fabric conditioner as will be known to the person skilled in the art. Among such materials there may be mentioned: salts, insect repellents, shading or hueing dyes, pH buffering agents, perfume carriers, hydrotropes, anti-redeposition agents, soil-release agents, polyelectrolytes, anti-shrinking agents, anti-wrinkle agents, anti-oxidants, dyes, colorants, sunscreens, anti-corrosion agents, drape imparting agents, anti-static agents, sequestrants and ironing aids. The products of the invention may contain pearlisers and/or opacifiers. A preferred sequestrant is HEDP, an abbreviation for Etidronic acid or 1-hydroxyethane 1,1-diphosphonic acid.

### Viscosity

The viscosity of the liquid fabric softener composition produced by the method described herein preferably has a viscosity of 200 to 400 mPas at a shear rate of 30 s⁻¹ and/or a viscosity 75 to 200 mPas at a shear rate of 106 s⁻¹. Preferably the viscosity at a shear rate of 30 s⁻¹ is 250 to 300 and/or the shear rate at a shear rate of 106 s⁻¹ is 100 to 150. Viscosity is measured using the MCR 302 Rheometer ex. Anton Paar, at ambient temperature, using plate and cone geometry (CP-50) and 2 degrees cone angle at 20° C.

### Method of Production

The solid fabric conditioning compositions of the present invention may be made via any suitable route. Preferably any liquid ingredients are premixed with a water soluble filler material to make a powdered composition. This powder is then mixed with all other dry ingredients. Preferably, once mixed the powder mix is sieved through a mesh of about 200 µm or smaller, preferably a mesh of 150 µm or smaller. The powder may be used as a powder or further processed into other suitable solid formats.

### In Home Preparation

The method described herein comprises the step of diluting a solid fabric conditioner composition with water to produce a liquid fabric conditioner composition which can be used according to consumer habit. In other words the method produces a fabric conditioner composition which the consumer then uses in the same way they would use any other liquid fabric conditioner. The method takes place prior to a laundry process. The liquid produced by the method is then used in a laundry process. The consumer may prepare the liquid fabric conditioner just before the laundry process or may prepare the liquid fabric conditioner days or weeks before using it in the laundry process. The laundry process is defined as the process in which clothes are washed, rinsed and dried.

The solid fabric conditioner composition comprises at least a fabric softening system and a polymer. Other ingredients may also be present in the solid fabric conditioner composition as described herein.

Preferably the ratio of solid fabric conditioner composition to water is 1:20 to 1:2 by weight, preferably 1:15 to 1:2 and most preferably 1:10 to 1:2.5.

The solid fabric conditioning composition may be diluted with water in any suitable receptacle, for example a bottle, a jug, a pot, a box, a bowl, i.e. any container suitable for containing a liquid composition. Preferably the receptacle has means for closing the receptible, i.e. for sealing the liquid fabric conditioner composition within the receptacle, for example a lid. Preferably a bottle is used, preferably the bottle has a lid.

Either the water or solid fabric conditioner composition may be placed in the receptacle first. However, preferably the solid fabric conditioner composition is placed in the receptacle first and the water added second. This leads to improved dissolution of the solid.

Mixing of the solid fabric conditioner composition and the water is not required, but is preferred. Mixing may occur by any method of agitating. Agitation may be of the receptacle in which the solid fabric conditioner composition and water are contained or agitating the water inside the receptacle. Preferred methods of agitation are shaking or stirring. Preferably mixing occurs for at least 10 seconds and less than 5 minutes, more preferably 20 seconds to 3 minutes.

### Method of Use

Once the solid fabric conditioning composition has been diluted and a liquid fabric conditioning composition produced, the liquid composition may be used in the same way as a conventional liquid fabric conditioner. The liquid may be used in hand washing or machine washing of fabrics. It is preferably used in the rinse stage of the washing process. When used in a washing machine, the liquid composition may be added manually or automatically dosed from the drawer compartment of an automatic washing machine.

The liquid fabric softening composition produced by the method described herein can be used to soften fabrics or to perfume the fabric.

### EXAMPLES

To demonstrate the effect of the fabric softening system described herein, compositions A-D and 1-6 were prepared and the viscosity measured.

TABLE 1

Compositions
wt.% in composition

| Ingredient | A | B | C | D | 1 | 2 | 3 | 4 | 5 | 6 |
|---|---|---|---|---|---|---|---|---|---|---|
| Cationic surfactant¹ | 17.25 | 34.5 | 51.45 | 69.41 | 34.41 | 57.45 | 62.1 | 34.41 | 57.45 | 62.1 |
| Non-ionic cosurfactant² | - | - | - | - | 34.41 | 17.25 | 6.9 | - | - | - |
| Cationic cosurfactant³ | - | - | - | - | - | - | - | 34.41 | 17.25 | 6.9 |
| Anti-foam | 0.83 | 0.83 | 0.83 | 0.83 | 0.83 | 0.83 | 0.83 | 0.83 | 0.83 | 0.83 |
| Free perfume | 10.18 | 10.18 | 10.18 | 10.18 | 10.18 | 10.18 | 10.18 | 10.18 | 10.18 | 10.18 |
| Perfume microcapsule | 4.82 | 4.82 | 4.82 | 4.82 | 4.82 | 4.82 | 4.82 | 4.82 | 4.82 | 4.82 |
| Filler and dispersant (Microcrystaline cellulose) | 13.76 | 13.76 | 13.76 | 13.76 | 13.76 | 13.76 | 13.76 | 13.76 | 13.76 | 13.76 |
| Additional Filler (Silica) | 51.45 | 34.5 | 17.25 | - | - | - | - | - | - | - |
| Minors | To 100 | To 100 | To 100 | To 100 | To 100 | To 100 | To 100 | To 100 | To 100 | To 100 |
| Total | 100 | 100 | 100 | 100 | 100 | 100 | 100 | 100 | 100 | 100 |

Cationic surfactant¹ - Di(hydrogenated Tallow) dimethyl ammonium chloride ex.

FEIXIANG CHEMICALS (ZHANGJIAGANG) CO. LTD

Non-ionic co-surfactant² - Lutensol AT-25 ex. BASF

Cationic co-surfactant³ - cetyl trimethyl ammonium chloride

### Preparation of Solid Composition

Three premixes where prepared:
Perfume microcapsules and Microcrystalline cellulose
A melt of the Dialky Quat, HEQ ester quat, non-ionic surfactant and free perfume
All other ingredients

The three premixes were combined in a mixer and sieved through a 120 µm mesh. The resulting powder is a solid fabric conditioning composition.

### Preparation of Liquid Composition

15 g of the powder as prepared above was added to a bottle, followed by 100 g of water. The water was at ambient temperature. The bottle was shaken for 1 minute. This resulted in the formation of a liquid fabric softening composition.

### Viscosity Measurement

The viscosity of the resulting liquid fabric conditioner compositions was measured using the MCR 302 Rheometer ex. Anton Paar, at ambient temperature, using plate and cone geometry (CP-50) and 2 degrees cone angle and a constant shear rate of 20 S⁻¹.

TABLE 2

Viscosity of liquid fabric softening compositions

| Composition | Fabric softening system | | | | Viscosity (centipoise) |
|---|---|---|---|---|---|
| | g of quat¹ in 100 ml | g of non-ionic co-surfactant² in 100 ml of | g of cationic co-surfactant³ in 100 ml of | Total fabric softening system in 100 ml (g) | |
| A | 2.5 | - | - | 2.5 | 528.56 |
| B | 5 | - | - | 5 | 1302.8 |
| C | 7.5 | - | - | 7.5 | 2410.6 |
| D | 10 | - | - | 10 | 4234 |
| 1 | 5 | 5 | - | 10 | 213.84 |
| 2 | 7.5 | 2.5 | - | 10 | 2491.1 |
| 3 | 9 | 1 | - | 10 | 1872.4 |
| 4 | 5 | - | 1.5 active (5 g as supplied) | 10 | 569.07 |
| 5 | 7.5 | - | 0.75 active (2.5 g as supplied) | 10 | 1857.1 |
| 6 | 9 | - | 0.3 active (1 g as supplied) | 10 | 3210 |

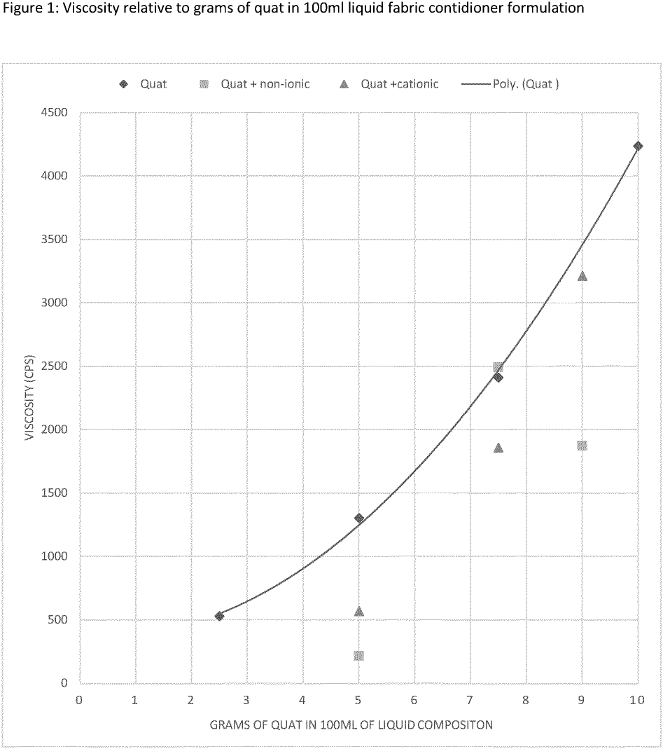

The viscosity is depicted in FIG. 1. The inclusion of a co-active reduces the viscosity of the liquid formulation, providing a suitable viscosity for a liquid fabric conditioner composition.

1. A solid fabric conditioner composition suitable for diluting with water to produce a liquid fabric conditioner composition, the solid fabric conditioner composition comprising:
a. 15 to 80 wt.% Fabric softening system comprising cationic quaternary ammonium compound having more than one long carbon chain in combination with a secondary surfactant selected from a single chain cationic surfactant and/or a non-ionic surfactant;
b. thickening polymer;
c. 0.1 to 18 wt.% free perfume; and
d. 0.1 to 15 wt.% perfume microcapsules;
wherein the ratio of cationic quaternary ammonium compound to secondary surfactant is 1:10 to 10:1.

2. A solid fabric conditioner composition according to claim 1, wherein the composition comprises 15 to 70 wt.% fabric softening system.

3. A solid fabric conditioner composition according to claim 1, wherein the quaternary ammonium compounds comprise one or more carbon chains having 10 to 30 carbons.

4. A solid fabric conditioner composition according to claim 1, wherein the composition comprises 0.1 to 10 wt.% thickening polymer.

5. A solid fabric conditioner composition according to claim 1, wherein the thickening polymer comprises an anionic polymer.

6. A solid fabric conditioner composition according to claim 1 wherein when the solid composition and water are combined in a ratio of 1:20 to 1:2 by weight a liquid is provided having a viscosity of 200 to 400 mPas at a shear rate of 30s⁻¹ and/or a viscosity 75 to 200 mPas at a shear rate of 106 s⁻¹ at 20° C.

7. A solid fabric conditioner composition according to claim 1 wherein the solid fabric conditioning composition comprises a disintegrant.

8. A method for in home preparation of a liquid fabric conditioner composition, wherein a solid composition according to claim 1 is diluted with water and a liquid fabric conditioner composition is produced, the method comprising the step of combining the solid composition and water.

9. A liquid fabric softening composition obtained by combining a solid fabric conditioner composition according to claim 1 with water.

10. Use of a solid fabric treatment composition according to claim 1, to prepare a liquid fabric treatment composition.

11. Use of the solid fabric conditioner composition according to claim 10, wherein the liquid fabric treatment composition is used to soften clothes.
